(19) United States
(12) Patent Application Publication
(10) Pub. No.: US 2005/0041184 A1
(43) Pub. Date: Feb. 24, 2005

(54) Liquid crystal display

(76) Inventor: Heng-Chung Wu, Hsin Chu Hsien (TW)

Correspondence Address: BIRCH STEWART KOLASCH & BIRCH, PO BOX 747, FALLS CHURCH, VA, 22040-0747, US

(21) Appl. No.: 10/849,232

(22) Filed: May 20, 2004

(30) Foreign Application Priority Data
Aug. 19, 2003 (TW) 92215032

(51) Int. Cl. G02F 1/1335

(52) U.S. Cl. 349/114

(57) ABSTRACT

An LCD includes a display module and a backlight module arranged below the displaying module. The displaying module includes an upper and lower transparent substrates, a liquid crystal layer formed between the upper and lower transparent substrates, a translucent reflecting layer formed between the liquid crystal layer and the lower transparent substrate, and an anti-reflection coating formed between the translucent reflecting layer and the lower transparent substrate. The backlight module is adjacent to the lower transparent substrate. Therefore, a first transmission rate of an inner light that passes from the backlight module to the displaying module is increased, and a luminance of the liquid crystal display is improved.

### BACKGROUND OF THE INVENTION

1. Field of the Invention

The present invention relates to a liquid crystal display (LCD). More particularly, the present invention relates to semi-reflection type LCD with back light; the LCD includes an anti-reflecting coating formed on a display module thereof, in order to raise the light transmission rate and to reduce the reflection rate in the meantime.

2. Background of the Invention

For demands of cell phones and PDAs, a semi-reflection type LCD with back light can be applicable to a portable display that should meet the requirements of low voltage and low power consumption. FIG. 1 illustrates a cross-sectional profile of a conventional semi-reflection type LCD 1a which includes a multi-layer displaying module and a backlight module 40 disposed under the displaying module. The displaying module includes a liquid crystal layer 30a, a translucent reflecting layer 26a disposed under the liquid crystal layer 30a, an upper transparent substrate 10a arranged above the liquid crystal layer 30a, a lower transparent substrate 20a arranged below the translucent reflecting layer 26a, an upper polarizing sheet 12a arranged upon the upper transparent substrate 10a, a lower polarizing sheet 22a disposed below the lower transparent substrate 20a, an upper retardation plate 14a arranged between the upper transparent substrate 10a and the upper polarizing sheet 12a, and a lower retardation plate 24a arranged between the lower transparent substrate 20a and the lower polarizing sheet 22a. The upper and lower polarizing sheets 21a, 22a polarizes the light for light traveling in particular directions. The upper and lower retardation plates 24a are capable of changing the phase of polarized light, so that the liquid crystal layer 30a can show a dark state without drive. The translucent reflecting layer 26a can let light partially pass therein and reflect the rest.

There are two categories of light sources in the conventional semi-reflection type LCD 1a; an external light L1 from outside and an inner light L2 from the backlight module 40a. For ease to utilize the external light L1, the translucent reflecting layer 26a is usually designed with some characters; for example, a proportion T1 of a transmission part to the total external light L1 is 60%, a proportion R1 of a reflection part to the total external light L1 is 30%, rest 10% of the total external light L1 is absorbed; simultaneously, a proportion R2 of a reflection part to the total inner light L2 is 60% and a proportion T2 of a transmission part to the total inner light L2 is 30%, and rest 10% of the total inner light L2 is absorbed, either. Obviously, the total inner light L2 from the backlight module 40a is utilized with low efficiency. When a reflection rate of the conventional semi-reflection type LCD 1a increases 1%, a transmission rate thereof decreases 1%. Luminance of the conventional semi-reflection type LCD 1a accordingly diminishes 1%. Thus, progress of both high transmission rate and low reflection rate of the conventional semi-reflection type LCD 1a is a top issue to persons skilled in the art.

Hence, the prior art improved is required to overcome the disadvantages thereof.

### SUMMARY OF INVENTION

The object of the invention is therefore to specify an LCD which includes an anti-reflection coating formed on a displaying module thereof, in order to provide both high transmission rate and low reflection rate.

According to the invention, this object is achieved by an LCD which includes a display module and a backlight module arranged below the displaying module. The displaying module includes an upper and lower transparent substrates, a liquid crystal layer, a translucent reflecting layer and an anti-reflection coating. The liquid crystal layer is formed between the upper and lower transparent substrates, the translucent reflecting layer is formed between the liquid crystal layer and the lower transparent substrate, and the anti-reflection coating is formed between the translucent reflecting layer and the lower transparent substrate. The backlight module is adjacent to the lower transparent substrate. Therefore, a first transmission rate of an inner light L2 that passes from the backlight module to the displaying module is increased, and a luminance of the liquid crystal display is improved.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. Of course, additional features of the invention will be described hereinafter and will form the subject of the claims appended hereto.

### BRIEF DESCRIPTION OF THE DRAWINGS

These and other features, aspects, and advantages of the present invention will become better understood with regard to the following description, appended claims, and accompanying drawings, where

FIG. 1 is a cross-sectional profile according to conventional semi-reflection type LCD; and

FIG. 2 is a cross-sectional profile of a semi-reflection type LCD according to the present invention.

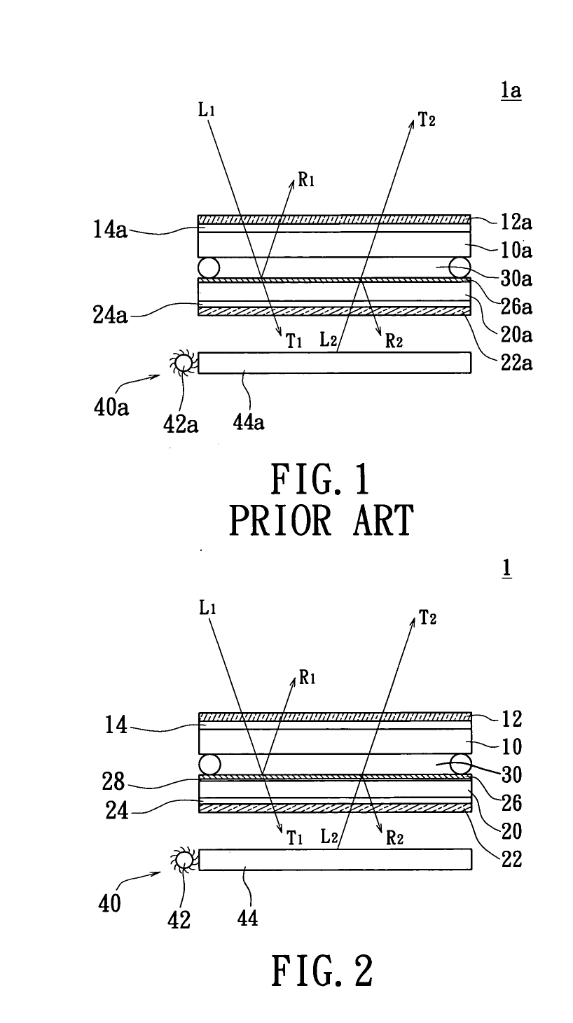

### DETAILED DESCRIPTION OF THE EMBODIMENTS

With respect to FIG. 2, the present invention provides a semi-reflection type LCD 1 with back light. The LCD 1 includes a displaying module (not indicated) and a backlight module 40 arranged below the displaying module. The displaying module includes a liquid crystal layer 30, an upper transparent substrate 10 arranged above the liquid crystal layer 30, a lower transparent substrate 20 arranged below the liquid crystal layer 30, a translucent reflecting layer 26 formed between the liquid crystal layer 30 and the lower transparent substrate 20, an upper polarizing sheet 12 arranged upon the upper transparent substrate 10, a lower polarizing sheet 22 disposed below the lower transparent substrate 20, an upper retardation plate 14 arranged between the upper transparent substrate 10 and the upper polarizing sheet 12, a lower retardation plate 24 arranged between the lower transparent substrate 20 and the lower polarizing sheet 22, and a first anti-reflection coating 28 formed between the translucent reflecting layer 26 and the lower transparent substrate 20. The backlight module 40 includes a light source 42 and a light guide plate 44. The light guide plate 44 is used to guide light which travels from the light source 42 to the user uniformly. Consequently, a first proportion of transmission part to an inner light L2 that passes from the backlight module 40 to the displaying module is increased, and a luminance of the liquid crystal display is improved.

The first anti-reflection coating 28, nowadays, can be provided to grow on the lower transparent substrate 20 through using evaporation deposition or sputter deposition processes. In an alternative manner, the first anti-reflection coating 28 can be adhered to the lower transparent substrate 20 via an adhesive layer arranged therebetween; a refraction rate of the adhesive layer is less than that of the lower transparent substrate 20 so as to avoid a total internal reflection. The first anti-reflection coating 28 is made of metallic materials, metallic oxides, or multi-layer films.

In conclusion, the present invention provides the LCD through adding the anti-reflection coating 28 for reducing the proportion R2 of the reflection part to the inner light L2 and for increasing the proportion T2 of the transmission part to the inner light L2, simultaneously; thus, the luminance of the LCD will be accordingly increased. Therefore, the power consumption that the present invention needs is less than that of prior art, equivalent brightness will be achieved. Furthermore, the service life of the LCD is prolonged.

In addition, the LCD according to another embodiment of the present invention has a second anti-reflection coating (not shown) formed above the backlight module 40, a second transmission rate of the inner light L2 that passes from the backlight module 40 to the translucent reflecting layer 26 is increased, and a reflection rate of the inner light L2 reflected by the translucent reflecting layer 26 is reduced.

There are some applications of an anti-reflecting film adopted for the conventional semi-reflection type LCD 1a, however, the anti-reflecting film is arranged above the outermost polarizing sheet to reduce both of a reflection rate of the external light and a reflected image on outermost polarizing sheet. The semi-reflection type conventional LCD 1a can further include an anti-reflecting coating arranged on the light guide plate 42 to reduce a reflection rate of the external light L1. The external light L1 may travel back to the displaying module by being reflected from the light guide plate 42, so as to make a double overlapping image shown on the outermost polarizing sheet and get a failure view. Obviously, the anti-reflecting coating referred in the present invention provides different objects and effective objects from those of the prior art.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. An liquid crystal display (LCD) comprising:
a displaying module including an upper and lower transparent substrates, a liquid crystal layer formed between the upper and lower transparent substrates, a translucent reflecting layer formed between the liquid crystal layer and the lower transparent substrate, and a first anti-reflection coating formed between the translucent reflecting layer and the lower transparent substrate; and
a backlight module arranged below the displaying module and adjacent to the lower transparent substrate,
whereby a first transmission rate of an inner light that passes from the backlight module to the displaying module is increased, and a luminance of the liquid crystal display is improved.

2. The liquid crystal display of claim 1, further including a second anti-reflecting coating formed above the backlight module, whereby a second transmission rate of the inner light that passes from the backlight module to the translucent reflecting layer is increased, and a reflection rate of the inner light reflected by the translucent reflecting layer is reduced.

3. The liquid crystal display of claim 1, wherein the first anti-reflection coating is grown on the lower transparent substrate in a sputter deposition process.

4. The liquid crystal display of claim 1, wherein the first anti-reflection coating is grown on the lower transparent substrate in an evaporation deposition process.

5. The liquid crystal display of claim 1, wherein the first anti-reflection coating is adhered to the lower transparent substrate via an adhesive layer arranged therebetween.

6. The liquid crystal display of claim 1, wherein the first anti-reflection coating is made of metallic materials, metallic oxides, or multi-layer films.
